(19) United States
(12) Patent Application Publication
(10) Pub. No.: US 2006/0173679 A1
(43) Pub. Date: Aug. 3, 2006

(54) Healthcare examination reporting system and method

(76) Inventors: Brian DelMonego, Chester Springs, PA (US); Betty Fink, Bear, DE (US); Gary Grzywacz, Harleysville, PA (US); James Pressler, West Chester, PA (US); Donald Taylor, Downingtown, PA (US); Arnold Teres, Broomall, PA (US)

Correspondence Address: Siemens Corporation;Intellectual Property Department, 170 Wood Avenue South, Iselin, NJ, 08830, US

(21) Appl. No.: 11/273,165

(22) Filed: Nov. 14, 2005

Related U.S. Application Data
(60) Provisional application No. 60/627,377, filed on Nov. 12, 2004.

(51) Int. Cl. G10L 15/26

(52) U.S. Cl. 704/235

(57) ABSTRACT

A system and method for managing recorded audio information concerning a patient's medical condition including receiving a signal comprising dictated information; processing the signal by parsing data representing the dictated information in the signal and identifying key words in the dictated information and providing data representing a text translation of the dictated information; populating an electronic form compatible with a reporting standard with a data item associated with the identified key word and with the text translation; and initiating generation of data representing a display image, enabling viewing of the populated electronic form and visual confirmation of data contained therein.

This is a non-provisional application of Provisional Application Serial No. 60/627,377 to Del Monego et al. filed Nov. 12, 2004.

### FIELD OF THE INVENTION

The embodiments of the present system relate to a computer-implemented healthcare examination reporting system and method, particularly to a system and method for automatically populating medical information system forms and automatically generating a corresponding patient letter for medical follow-up.

### BACKGROUND OF THE INVENTION

Typically with healthcare examination reporting systems, the reporting procedure is initiated in response to needed DICOM-objects (Digital Imaging and Communications in Medicine) or images taken by a variety of modalities including, but not limited to, MRI (magnetic resonance imaging), radiology, x-ray, and the like. In performing and reporting a patient assessment, a physician or other qualified user is required to manually enter the assessment results into a variety of existing medical information systems such as, for example, a Radiology Information Systems (RIS). Typically Radiology Information Systems are labor-intensive, requiring many navigational clicks where the user manually points and clicks in a Mammography Exam Entry Module to enter assessment results. As a result of the burden of data entry, the physician may not enter the assessment results. However in order to ensure entry of the assessment results, nurses or other staff members are required to translate the spoken text or dictated assessment results and manually insert them into a Radiology Information System report. The non-physician staff can misinterpret the assessment results and enter the incorrect information into the RIS. Misinterpretation and errors are particularly likely if a report is translated by a person who is unaware of the technical or clinical words, key words or values utilized by the particular RIS. As a result of the errors, there is a delay in the distributing and communicating of patient letters for the mammography follow-up and, therefore, delayed delivery of patient care.

Thus, there is a need within the industry for a system and method that maximizes efficiency with respect to the entry of a physician's dictated examination assessment results into a medical information system, such that appropriate follow-up, which includes reporting of findings and follow-up letters to patients, patient letters occurs in a timely fashion.

### SUMMARY OF THE INVENTION

An exemplary embodiment of the present system comprises a system for managing audio information concerning a patient's medical condition comprising an interface for receiving a signal comprising dictated information concerning a patient's medical condition, including dictated patient identification information; a voice recognition processor for automatically processing the signal by parsing data representing the dictated information in the signal, identifying key words in the dictated information and providing data representing a text translation of the dictated information; a form processor for populating an electronic form with at least one data item associated with an identified key word and with the text translation, wherein the electronic form is compatible with a reporting standard; and a display processor for initiating generation of data representing a display image, enabling viewing of the populated electronic form and visual confirmation of data contained therein.

### BRIEF DESCRIPTION OF THE DRAWINGS

All functions and process shown by the Figures may be implemented in hardware, software or a combination of both.

FIG. 1 is a block diagram showing a computer system according to an exemplary embodiment of the present system.

FIG. 2 is a block diagram showing computer system according to an exemplary embodiment of the present system.

FIG. 3 is a block diagram showing a method according to an exemplary embodiment of the present system.

### DETAILED DESCRIPTION

Although the embodiments of the present system are described in the context of a radiology department, this is exemplary only. The embodiments of the present system are also applicable in other hospital departments (e.g., cardiology) or medical disciplines (e.g., dentistry or veterinary medicine) that utilize medical subspecialty software. In addition the embodiments of the present system are described in conjunction with BI-RADS® (Breast Imaging Reporting and Data System, a product of The American College of Radiology). BI-RADS is a quality assurance tool or system known in the art designed to standardize mammography reporting, reduce confusion in breast imaging interpretations and facilitate outcome monitoring. BI-RADS utilizes a standardized imaging lexicon, reporting organization and assessment categories. Exemplary assessment categories range from Category 0 (Needs additional imaging evaluation) to Category 5 (Highly suggestive of malignancy—appropriate action should be taken). Thus, BI-RADS communicates the assessment results to a user in a clear fashion that indicates a specific course of action. The results are compiled in a standardized manner that permits the maintenance and collection analysis of demographic, mammography and outcome data. Furthermore, BI-RADS allows for medical audits and outcome monitoring, which provides important peer review and quality assurance data to improve the quality of patient care. The use of BI-RADS is only for exemplary purposes. Thus, the embodiments of the present system recognize and translate the standardized lexicon of BI-RADS or any other medical subspecialty software.

An embodiment of the present system comprises a computer-implemented system and method for managing audio information concerning a patient's medical condition by detecting the spoken words or dictation (preferably recorded dictation) of a user (e.g., a physician such as a radiologist) and translating these words to produce the appropriate key words or lexicon (preferably mammography-specific standardized lexicon) that are used to automatically populate at least one data field in a particular electronic form (e.g., a BI-RADS form as described below) contained in a database, where the at least one data field is associated with an identified key word and with text translation. Thus, no manual intervention is required to populate the at least one data field of the electronic form, thereby reducing or eliminating errors resulting from human intervention and minimizing the time required to enter assessment results into the electronic form. The embodiments of the present system also allow for the generating of patient letters to be integrated within a RIS used for reporting medical information. The patient letters are preferably automatically generated.

The embodiments of the present system do not require that the spoken or dictated reports generated by a physician be stored in addition to the storage of the populated electronic forms. The embodiments automatically store the populated electronic forms, but not necessarily the dictated reports, thereby resulting in less data having to be stored and communicated via a network (less data traffic).

The dictation from the physician is received by the embodiments of the present system via an interface that receives a signal comprising dictated information concerning a patient's medical condition, for example, mammography assessment results or patient identification information.

The embodiments of the present system use a voice to text dictation system and method (e.g., voice recognition software) for detecting the spoken words or dictation of a physician and interpreting, translating and transforming the dictation to produce the appropriate mammography-specific key words or lexicon as a written report, where the voice to text dictation system is generally known to those skilled in the art. Thus, these embodiments preferably avoid the requirement that a physician follow a step-by-step process for each entry (e.g., BI-RADS key words such as “calcification,” “mass,” “asymmetric density,” and “architectural distortion”) needed to be inserted into the electronic form. The reporting physician speaks using his/her own statements, which are subsequently transformed into the standard BI-RADS lexicon for automatic entry into a RIS report. A physician using the voice to text dictation system typically initializes the system to recognize his or her particular voice. Therefore, the physician assesses a patient that has a mammography procedure that has been tracked to the appropriate step in order to initiate voice to text dictation. The physician dictates the information along with the BI-RADS key words for assessment, site, findings and recommendation, wherein the at least one data field of the electronic RIS form or other predetermined electronic form is automatically populated with predetermined standardized lexicon (data representing an identified key word).

The voice to text component uses a free speech method for the interpretation, translation and transformation of the physician's dictated information. Thus the systeem finds key words within the spoken report and finds the associated values to support recognition the keywords and associates the assigned keywords of the report with the recognized values. Using this method the physician's dictated information is analyzed by automatically processing the signal as described above, thereby parsing the data representing the dictated information, identifying key words and then linking the key words with the associated BI-RADS value(s) to provide data representing a text translation of the dictated assessment results. Thus, the voice to text component recognizes ambiguous BI-RADS lexicon in dictated information and applies contextual and grammar analysis to assign different (correct) clinician words or statements to the identified ambiguous terms. The embodiments of the present system provide accurate BI-RADS compatible information, thereby helping to ensure consistently accurate and BI-RADS compliant RIS reports.

The embodiments of the present system further indicate a particular patient is to receive a follow up patient letter and automatically initiate the communication with workers (e.g., a clinician) that a patient needs medical follow-up. Alternatively, the embodiments of the present system automatically initiate assigning a worker the task of dispatching a patient letter or automatically generate the patient follow-up letter. Thus, in response to the standard lexicon populated into the BI-RADS compliant electronic form and the subsequent RIS report, a clinician, nurse or other worker schedules a patient for a follow-up appointment(s).

In another embodiment, the present system guides the physician or other user through dictation of information according to the word recognition and assignment procedure on a step-by-step basis using at least one of either voice directions or a display image indicating directions. Thus, the embodiments of the present system are interactive, whereby the user responds by using any of a number of user interface methods including, but not limited to, voice input method (e.g., microphone), keyboard or mouse clicks.

In still another embodiment, the present system indicates the scope of an expected or anticipated answer to the reporting physician by providing prompts designed to elicit a response comprising a recognized key word or other optional answer. Exemplary prompts include the following: “Do you see any black areas?” and “If yes, where are such black areas?”. Thus, the embodiments of the present system may use a step-by-step approach, again, using at least one of either voice directions or a display image indicating directions. As a result of these prompts to elicit the anticipated response, the database is populated with the recognized lexicon and/or values. Subsequently, as noted above, a follow up letter is automatically generated for the patient based on the recognized lexicon and/or values.

In some instances, embodiments of the present system are unable to assign relevant standard BI-RADS compliant lexicon to particular spoken words of the dictation of the physician or cannot not find the needed values when a word is ambiguous or unrecognizable. Thus, the present system prompts the user for more specific values or meaning to the physician's language.

Preferably all of the policy and content with respect to carrying out or remaining compliant with BI-RADS is integrated into the electronic form for each report where the electronic form is automatically updated to be compatible with the latest requirements set by one or more of a standards body (e.g., the American College of Radiology), a healthcare organization and/or a hospital. For this reason, the user automatically obtains the newest program updates (e.g., updates to BI-RADS).

Using the computer-implemented system and method according to the embodiments of the present system a hospital or other medical office is able to automate workflow and either eliminate or reduce user interaction and produces a BI-RADS compatible report as well as patient letters in response to the report compilation. Furthermore the embodiments of the present system assign, store and update key BI-RADS compatible lexicon in a database without human intervention. The reporting physician need only to review the final report. Thus, the hospital or other medical facility operates more efficiently and provides more effective patient care.

The present embodiments are preferably implemented on a computer, or network of computers as an executable application. The executable application displays on a computer screen, the electronic form assigned to a selected procedure or medical department and enables the voice recognition software to translate the physician's dictation and translate and transform it into a written report, and populate the electronic form with the relevant standard BI-RADS compatible lexicon. The executable application preferably also allows for the generating of a patient letter for mammography follow-up.

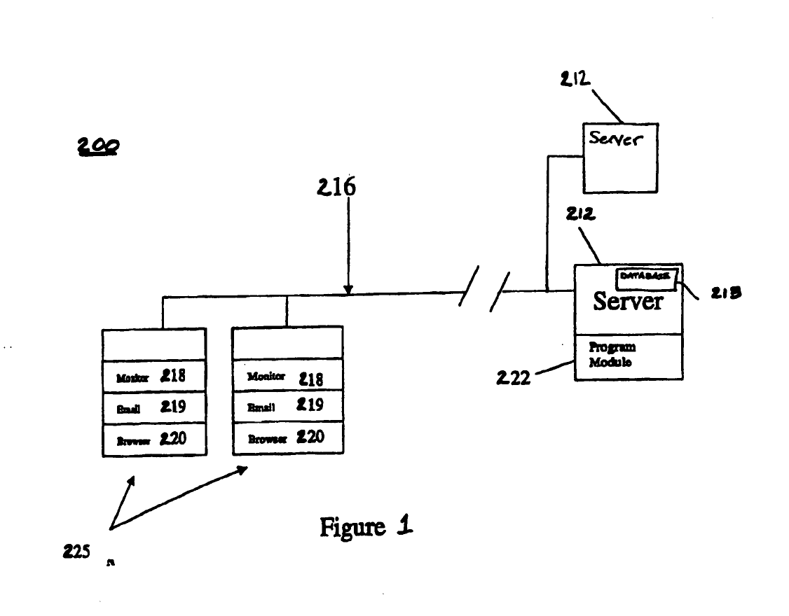

FIG. 1 shows a client-server computer system 200, which may be utilized to carry out a method according to an exemplary embodiment of the present system. The computer system 200 includes a plurality of server computers 212 and a plurality of user computers 225 (clients). The server computers 212 and the user computers 225 may be connected by a network 216, such as for example, an Intranet or the Internet. The user computers 225 may be connected to the network 216 by a dial-up modem connection, a Local Area Network (LAN), a Wide Area Network (WAN), cable modem, digital subscriber line (DSL), or other equivalent connection means (whether wired or wireless).

Each user computer 225 preferably includes a video monitor 218 for displaying information. Additionally, each user computer 225 preferably includes an electronic mail (e-mail) program 219 (e.g., Microsoft Outlook®) and a browser program 220 (e.g. Microsoft Internet Explorer®, Netscape Navigator®, etc.), as is well known in the art. Each user computer may also include various other programs to facilitate communications (e.g., Instant Messenger™, NetMeeting™, etc.), as is well known in the art.

One or more of the server computers 212 preferably include a program module 222 (i.e., the executable application described above) which allows the user computers 225 to communicate with the server computers 212 and each other over the network 216. The program module 222 may include program code, preferably written in Hypertext Mark-up Language (HTML), JAVA™ (Sun Microsystems, Inc.), Active Server Pages (ASP) and/or Extensible Markup Language (XML), which allows the user computers 225 to access the program module through browsers 220 (i.e., by entering a proper Uniform Resource Locator (URL) address). The exemplary program module 222 also preferably includes program code for facilitating a method of simulating leadership activity among the user computers 225, as explained in detail below.

At least one of the server computers 212 also includes a database 213 for storing information utilized by the program module 222 in order to carry out the embodiments of the method for detecting the spoken words or dictation information and interpret, translate and transform these words to produce the appropriate key words or lexicon that are used to automatically populate at least one data field in a particular electronic form. For example the spoken or dictated reports generated by a physician and/or the populated electronic forms may be stored in the database. Although the database 213 is preferably internal to the server, those of ordinary skill in the art will realize that the database 213 may alternatively comprise an external database. Additionally, although the database 213 is preferably a single database as shown in FIG. 1, those of ordinary skill in the art will realize that the present computer system may include one or more databases coupled to the network 216.

Various embodiments of the present system also include a computer-readable medium having embodied thereon a computer program for processing by a machine, the computer program comprising a segment of code for each of the method steps. The embodiments of the present system also include a computer data signal embodied in a carrier wave comprising each of the aforementioned code segments.

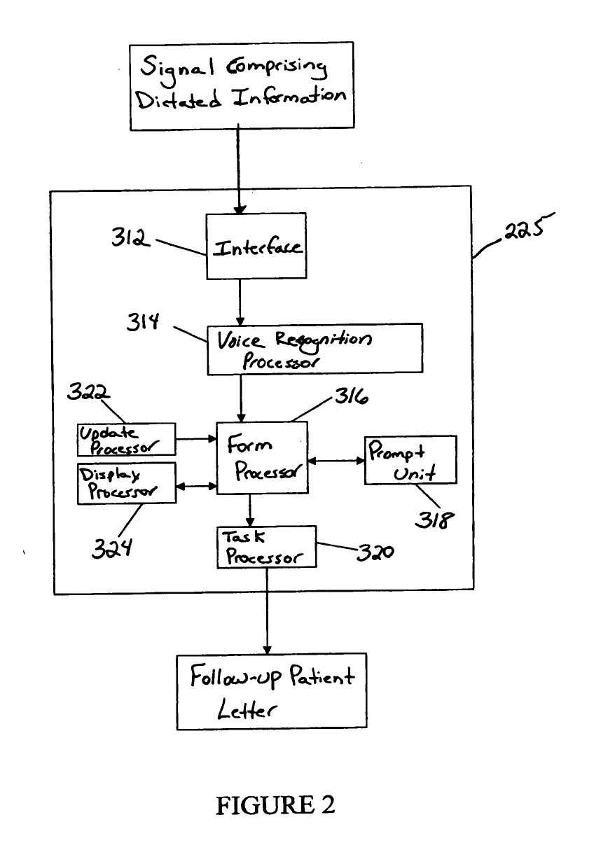

In order to perform some of the functions of the method for managing audio information concerning a patient's medical condition, as illustrated in the exemplary embodiment of FIG. 2, at least one of the user computers 225 or server computers 212 may include an interface 312 for receiving a signal comprising dictated information regarding a patient's medical condition. At least one of the user computers 225 or server computers 212 may also include a voice recognition processor 314 for automatically processing the signal by parsing the data representing the dictated information, identifying key words and linking the key words in the dictated information with the appropriate associated electronic form value(s) to provide data representing a text translation of the dictated information. At least one of the user computers 225 or server computers 212 may also include a form processor 316 for retrieving the electronic form from a database and/or populating at least one data field of the electronic form with at least one data item associated with the identified key word and with the text translation. At least one of the user computers 225 or server computers 212 may also include a prompt unit 318 for prompting a user with optional answers or guiding a user through dictation of a report. At least one of the user computers 225 or server computers 212 may also include a task processor 320 to automatically initiate the communication to workers that a patient is in need of medical follow-up and/or to automatically initiate assigning a worker the task of dispatching a patient letter and/or automatically generating a patient letter. At least one of the user computers 225 or server computers 212 may also include an update processor 322 that automatically updates the electronic form to be compatible with the latest requirements set by one or more of a standards body, hospital or healthcare organization. At least one of the user computers 225 or server computers 212 may also include a display processor 324 for initiating generation of data representing a display image, enabling viewing of the electronic form and visual confirmation of the data contained therein.

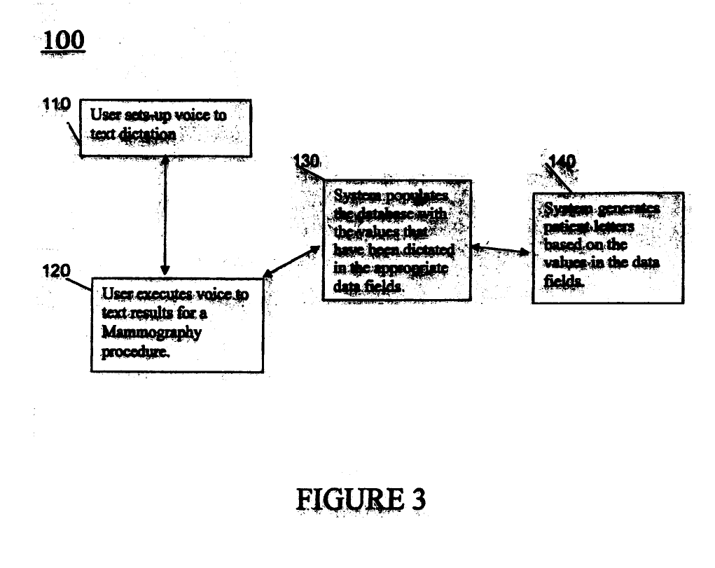

FIG. 3 is a block flow diagram showing an exemplary method 100 for automatically populating a medical information report that includes a first step 110 of a user initializing the voice to text dictation module so that it recognizes key words from dictated information. At step 120, subsequent to examining a patient, the reporting physician dictates the assessment results, preferably into a user interface. At step 130, the electronic form is populated with at least one data item associated with an identified key word and with text that has been translated and transformed from the dictated assessment results. At step 140, based on the populated data fields, a patient letter is automatically generated to inform the patient that a follow-up medical appointment is necessary.

An executable application as used herein comprises code or machine-readable instruction for implementing pre-determined functions, including those of an operating system, healthcare information system or other information processing systems, for example, in response to a user command or input. An executable procedure is a segment of code (machine-readable instruction), subroutine, or other distinct section of code or portion of an executable application for performing one or more particular processes and, may include performing operations on received input parameters (or in response to received input parameters) and provide resulting output parameters.

A processor as used herein is a device and/or set machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

Although the system has been described in terms of exemplary embodiments, it is not limited thereto. Rather, the appended claims should be construed broadly to include other variants and embodiments of the system which may be made by those skilled in the art without departing from the scope and range of equivalents of the system

What is claimed is:

1. A system for managing audio information concerning a patient's medical condition, comprising:
an interface for receiving a signal comprising dictated information;
a voice recognition processor for automatically processing the signal by parsing data representing the dictated information in the signal and identifying key words in the dictated information and providing data representing a text translation of the dictated information;
a form processor for populating an electronic form compatible with a reporting standard with a data item associated with the identified key word and with the text translation; and
a display processor for initiating generation of data representing a display image, enabling viewing of the populated electronic form and visual confirmation of data contained therein.

2. The system according to claim 1, further comprising a prompt unit for prompting a user for more specific answers or with optional answers.

3. The system according to claim 2, wherein the prompt unit provides at least one of voice directions and a display image indicating directions.

4. The system according to claim 1, further comprising a prompt unit for guiding a user through dictation of a report.

5. The system according to claim 4, wherein the prompt unit provides at least one of voice directions and a display image indicating directions.

6. The system according to claim 1, further comprising a database containing the electronic form compatible with the reporting standard, wherein the form processor retrieves the electronic form for populating.

7. The system according to claim 6, including an update processor for automatically updating the electronic form in the database to be compatible with the latest requirements of one or more of a standards body, healthcare organization and hospital.

8. The system according to claim 1, further comprising a task processor for automatically initiating alteration in a task schedule of a worker in response to data entered in the electronic form.

9. The system according to claim 1, further comprising a task processor for automatically initiating at least one of, (a) communication of a message, (b) assigning a task to a worker to initiate sending a letter, in response to data entered in the electronic form and (c) generating a patient letter.

10. The system according to claim 1, wherein the dictated audio information is recorded.

11. The system according to claim 9, wherein the patient letter is generated automatically.

12. A method for managing audio information comprising:
receiving a signal comprising dictated information;
processing the signal by parsing data representing the dictated information in the signal and identifying key words in the dictated information and providing data representing a text translation of the dictated information;
populating an electronic form compatible with a reporting standard with a data item associated with the identified key word and with the text translation; and
initiating generation of data representing a display image, enabling viewing of the populated electronic form and visual confirmation of data contained therein.

13. The method according to claim 12, further comprising generating a patient letter.

14. The method according to claim 13, wherein the patient letter is automatically generated.

15. The method according to claim 12, further comprising prompting a user for more specific answers or optional answers using at least one of voice directions and a display image indicating directions.

16. The method according to claim 12, further comprising prompting a user for guiding the user through dictation of a report using at least one of voice directions and a display image indicating directions.

17. The method according to claim 12, further comprising automatically updating the electronic form in a database to be compatible with the latest requirements of one or more of a standards body, a healthcare organization and a hospital.

18. The method according to claim 12, according to claim 1, further comprising automatically initiating alteration in a task schedule of a worker in response to data entered in the electronic form.

19. The method according to claim 12, further comprising automatically initiating at least one of, (a) communication of a message, (b) assigning a task to a worker to initiate sending a patient letter, in response to data entered in the electronic form, and (c) generating a patient letter.

20. A computer system comprising at least one server computer; and at least one user computer coupled to at least one server through a network, wherein the at least one server computer includes at least one program stored therein, said program performing the steps of:
receiving a signal comprising dictated information;
processing the signal by parsing data representing the dictated information in the signal and identifying key words in the dictated information and providing data representing a text translation of the dictated information;
populating an electronic form compatible with a reporting standard with a data item associated with the identified key word and with the text translation; and
initiating generation of data representing a display image, enabling viewing of the populated electronic form and visual confirmation of data contained therein.

21. The method according to claim 20, further comprising generating a patient letter.

22. The method according to claim 21, wherein the patient letter is automatically generated.

23. A computer readable medium having embodied thereon a computer program for processing by a machine, the computer program comprising:
a first segment of code for receiving a signal comprising dictated information;
a second segment of code for processing the signal by parsing data representing the dictated information in the signal and identifying key words in the dictated information and providing data representing a text translation of the dictated information;
a third segment of code for populating an electronic form compatible with a reporting standard with a data item associated with the identified key word and with the text translation; and
a fourth segment of code for initiating generation of data representing a display image, enabling viewing of the populated electronic form and visual confirmation of data contained therein.

24. The method according to claim 23, further comprising a fifth segment of code for generating a patient letter.

25. The method according to claim 24, wherein the patient letter is automatically generated.

26. A computer data signal embodied in a carrier wave comprising:
a first segment of code for receiving a signal comprising dictated information;
a second segment of code for processing the signal by parsing data representing the dictated information in the signal and identifying key words in the dictated information and providing data representing a text translation of the dictated information;
a third segment of code for populating an electronic form compatible with a reporting standard with a data item associated with the identified key word and with the text translation; and
a fourth segment of code for initiating generation of data representing a display image, enabling viewing of the populated electronic form and visual confirmation of data contained therein.

27. The method according to claim 26, further comprising a fifth segment of code for generating a patient letter.

28. The method according to claim 27, wherein the patient letter is automatically generated.
